(19) United States
(12) Patent Application Publication
(10) Pub. No.: US 2008/0301053 A1
(43) Pub. Date: Dec. 4, 2008

(54) SERVICE BROKER

(75) Inventors: Alex Tserkovny, Brookline, MA (US); Antoinette F. Hershey, Acton, MA (US); Thomas J. Antell, Westford, MA (US); Michael A. Weintraub, Medfield, MA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Services Organization Inc., Irving, TX (US)

(21) Appl. No.: 11/754,676

(22) Filed: May 29, 2007

(51) Int. Cl. H04L 9/00

(52) U.S. Cl. 705/54

(57) ABSTRACT

A method, associated with a platform that includes a number of distributed proxies and a hub, includes receiving, at a first proxy, a communication from a first entity intended for a second entity and forwarding control information to the hub. The method may also include identifying parameters associated with communications between the first and second entities and forwarding the parameters to the first proxy. The method may further include processing, by the first proxy, the communication in accordance with the parameters, forwarding, by the proxy, the processed communication to a second proxy, and forwarding, by the second proxy, the processed communication to the second entity.

### BACKGROUND INFORMATION

Exchanging information over networks has become increasingly common. For example, businesses often exchange business related data over the Internet with customers, suppliers and other business partners. Ensuring that these communications are secure and reliable is very important to both the entity originating the communication and the entity receiving the communication.

### BRIEF DESCRIPTION OF THE DRAWINGS

FIG. 1 schematically illustrates an exemplary architecture in which systems and methods described herein may be implemented;

FIG. 2 illustrates an exemplary network in which systems and methods described herein may be implemented;

FIG. 3 illustrates an exemplary configuration of components of the management hub of FIG. 2; and

FIGS. 4 and 5A-5C illustrate exemplary processing by various devices illustrated in FIG. 2.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention. Instead, the scope of the invention is defined by the appended claims and their equivalents.

Implementations described herein relate to an infrastructure for allowing various entities to exchange information. The infrastructure facilitates transactions and the exchange of information in a reliable, secure and accountable manner. The infrastructure may also allow various entities that use different systems that execute different networking protocols/standards to exchange data without requiring the entities to make significant changes to their systems or equipment.

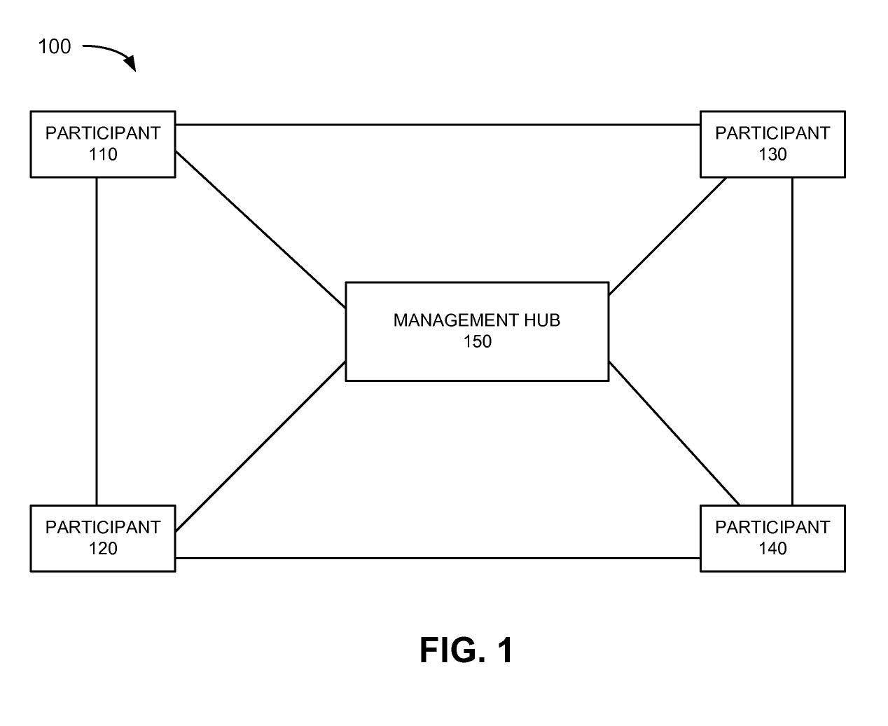

FIG. 1 is a block diagram schematically illustrating an exemplary system/system architecture 100 in which systems and methods described herein may be implemented. Referring to FIG. 1, system 100 includes participants 110, 120, 130 and 140 and management hub 150. The exemplary configuration illustrated in FIG. 1 is provided for simplicity. It should be understood that a typical system may include more or fewer devices than illustrated in FIG. 1.

Participants 110-140 may represent providers, consumers and other clients/entities that wish to exchange information, provide services, receive services, etc. Each of participants 110-140 may include a device, such as a work station, a personal computer (PC), a laptop computer, a personal digital assistant (PDA), a web-based appliance, a wireless telephone or another type of computation or communication device, or a process running on one of these devices. Participants 110-140 may communicate with management hub 150 and other ones of participants over a network (not shown) via wired, wireless or optical connections.

Management hub 150, also referred to herein as a platform or a management platform, may include a server/computing device, or a set of servers/computing devices, that provides participants 110-140 with secure and accountable communications with other ones of participants 110-140. In general, management hub 150 may act as a service broker and/or manager to allow participants 110-140 to communicate with one another on a managed peer-to-peer basis.

In an exemplary implementation, participants 110-140 may communicate with both management hub 150 and other ones of participants 110-140. In one implementation, participants 110-140 may subscribe to services provided by management hub 150. These services may include services associated with allowing participants to communicate with one another, exchange information, etc. Once each of the various participants 110-140 have selected desired services to which they would like to subscribe, management hub 150 may provision for the particular services to ensure that participants 110-140 can, for example, communicate with each other in a seamless and secure manner even when ones of participants 110-140 have systems that operate in accordance with different standards/protocols than other ones of participants 110-140. That is, management hub 150 may provide for inter-operability between participants 110-140 and also provide security-related processing and other processing for facilitating communications between participants 110-140.

Participants 110-140 may forward information to management hub 150 via proxies (not shown in FIG. 1). For example, proxies may forward control and/or management information to management hub 150 for communications involving participants 110-140. This control/management information may be service management information (SMI) that may include, for example, information regarding the size of messages, time stamp information and other identification information that may be used to trace back, if necessary, the history of each transaction in system 100. This SMI may be used, for example, for non-repudiation purposes. Management hub 150 may also authenticate clients 110-140, encrypt messages, sign messages and compress messages prior to routing messages to the appropriate destination (e.g., a target service uniform resource locator (URL)). Management hub 150 may also use the received SMI for billing, auditing, network monitoring, statistical analysis or other purposes associated with transactions involving participants 110-140, as described in detail below. As one example, management hub 150 may gather metering information, such as the amount of data transmitted, response times of participants 110-140, etc., to provide for accurate billing for participants 110-140 based on the particular services provided and to ensure, for example, that the communications satisfied various quality of service (QoS) related requirements, service level agreements (SLAs), etc.

Participants 110-140 may also communicate content information and/or message data to other ones of participants 110-140 via one or more proxies. In an exemplary implementation, some or all of the content information/message data may be sent to other ones of participants 110-140 via proxies that ensure that participants 110-140 are able to process the received content, as described in detail below. The proxies may also provide various security services, such as encryption and decryption of message data.

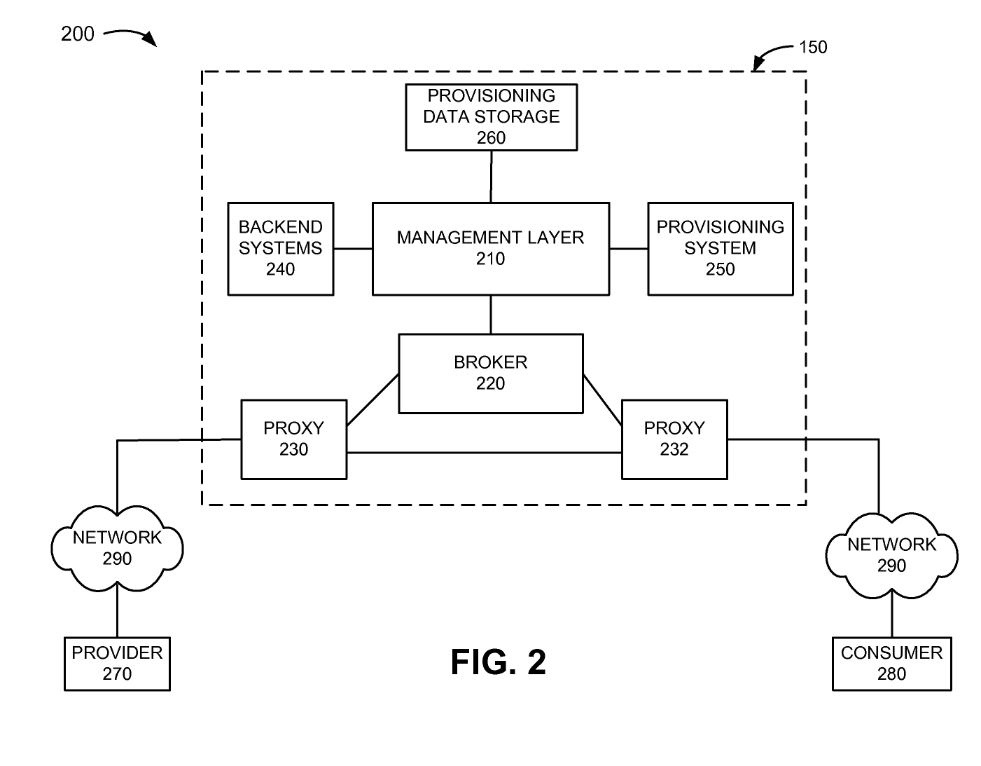

FIG. 2 illustrates a configuration of an exemplary network 200 in which methods and systems described herein may be implemented. Referring to FIG. 2, network 200 includes management hub 150 (illustrated within the dotted box), provider 270, consumer 280, and network 290. Management hub 150 may include management layer 210, broker 220, proxy 230, proxy 232, backend systems 240, provisioning system 250 and provisioning data storage 260. The configuration associated with network 200 in FIG. 2 is provided for simplicity. It should be understood that additional components and/or different components may be included in network 200. For example, various routers, switches, gateways (not shown) may be included in network 200 for routing purposes. In addition, management hub 150 may include additional devices, such as additional proxies for routing data to and from subscribers of the services of management hub 150.

In general, management hub 150 may provide delivery related functions and system related functions associated with managing communication sessions in network 200. The delivery related functions may include, for example, security related processing, message validation, transport and routing of messages, ensuring quality of service (QoS), non-repudiation services, providing service level agreements (SLAs), ensuring that the communication sessions meet QoS requirements and SLAs, versioning related processing, transformation and mapping of different protocols for compatibility and compliance with various standards and protocols and other delivery related functions. The system related functions may include, for example, monitoring, auditing, provisioning, accounting and billing, performance management, statistical analysis, load balancing, fail over or fail safe processing and other system related functions. The particular delivery and security related functions may be divided among components in management hub 150, as described in more detail below.

Management layer 210 may perform various functions associated with managing the operations of management hub 150. For example, management layer 210 may maintain information associated with subscribers of the services of management hub 150. Management layer 210 may use this information to make policy decisions governing business transactions. This information may include provisioning information about subscribers, along with electronic business policies that control the exchange of business data in a secure, accountable and highly trusted manner. Management layer 210 may also monitor all business transactions and provide control processing and data retrieval necessary to broker services between subscribers. In an exemplary implementation, management layer 210 may be associated with providing web-related services to subscribers. In other implementations, management layer 210 may provide any particular services to subscribers based on the particular subscribers.

Broker 220 may provide and guarantee secure and highly accountable data exchanges between providers and consumers, such as provider 270 and consumer 280. For example, broker 220 may enforce business data exchange policies and monitor business transactions via its communications with management layer 210. Broker 220 may receive message control directives from a proxy (e.g., one of proxies 230 or 232) and send access entitlements, URL addresses and transformation schemas to another proxy. In addition, broker 220 may also receive the delivery status of a transaction, security alerts and process statistics from the proxies 230 and 232. In an exemplary implementation, the centralized broker 220 and the distributed proxies (e.g., proxies 230 and 232) may use simple object access protocol (SOAP) messages to communicate with each other.

Proxies 230 and 232 allow participants who conduct business transactions with other parties to exchange data in a secure, accountable and highly trusted manner. Proxies 230 and 232 may act as interfaces or gateways to those business information systems that, for example, use or host various service, such as web services. For example, proxies 230 and 232 may interact with broker 220 to perform address resolution and may forward/receive information associated with transactions between subscribers or customers. Proxies 230 and 232 may also provide various security related functions. For example, proxies 230 and 232 may provide message validation and extensible markup language (XML) encryption. Proxies 230 and 232 may also perform XML parsing, message transformations (e.g., extensible stylesheet language (XSL) transformations) and message compression via, for example, adherence to web services standards or adherence to agreed upon parameters. Proxies 230 and 232 may also gather management data, such as response times and metering information. Proxies 230 and 232 may also queue messages locally. Proxies 230 and 232 may further interact with broker 220 and management layer 210 to perform dynamic routing to other proxies in network 200. The dynamic routing may be used for load balancing the handling of messages among a number of proxies in network 200, to avoid proxies that may be undergoing maintenance or are experiencing problems (e.g., as a failsafe or failover mechanism), or for other reasons.

In an exemplary implementation, each of the proxies in network 200 (e.g., proxies 230 and 232 and other proxies that are not shown) may forward transaction information associated with a communication session between two subscribers (e.g., provider 270 and consumer 280) to broker 220 each time that the proxy receives a communication in network 200. This transaction information may be stored and used by other devices/systems in network 200, such as backend systems 240, as described in detail below.

Backend systems 240 may receive usage information from management layer 210 and use this information for various purposes. For example, backend systems 240 may include a billing system, an auditing system, a network monitoring system, a statistical analysis system and other systems associated with billing, auditing, monitoring, analyzing, etc., transactions involving subscribers (e.g., providers and consumers in network 200, such as provider 270 and consumer 280). As an example, a billing system included in backend systems 240 may generate billing information for subscribers. As another example, an auditing system included in backend systems 240 may audit transactions involving subscribers. As still another example, a monitoring system including in backend systems 240 may monitor transactions for QoS purposes, to ensure that the transactions meet a previously agreed upon SLA, etc.

Provisioning system 250 may include provisioning information used by management layer 210 to ensure that customers are able to communicate in a seamless, transparent manner in accordance with agreed to protocols, standards, etc. For example, provisioning system 250 may allow subscribers, such as provider 270 and consumer 280, to communicate in accordance with SLAs regarding the exchange of information between these entities. These SLAs may include agreed upon security measures required for communications between these entities. Provisioning data storage 260 may include various data, such as subscriber data associated with subscribers of various services (e.g., web services) in network 200. Management layer 210 may store and/or use this information when setting up a service between entities in network 200.

Provider 270 and consumer 280 may correspond to two of participants 110-140 illustrated in FIG. 1. In an exemplary implementation, provider 270 may represent a provider of goods, services (e.g., web services), information, etc. Consumer 280 may represent a consumer of goods, services, information, etc., provided by provider 270. Provider 270 and consumer 280 may interact with each other via management hub 150 in a transparent manner. That is, consumer 280 may request information from provider 270 and management hub 150 may facilitate the transaction such that provider 270 and consumer 280 have little to no processing burden associated with the transaction, other than to provide the previously agreed upon service, information, etc., as described in detail below.

Network 290 may include one or more networks, such as a local area network (LAN), a wide area network (WAN), a metropolitan area network (MAN), a telephone network, such as the Public Switched Telephone Network (PSTN), the Internet, a cellular network, a satellite network, another type of network that is capable of transmitting data from a source device to a destination device or a combination of networks. Network 290 may also include one or more wireless networks for receiving wireless signals and forwarding the wireless signals toward the intended destination.

Firewalls that are located at provider's 270 and/or consumer's 280 location (not shown) may also be included in network 200 to provide additional protection to provider 270 and consumer 280, respectively. For example, firewalls may be coupled to provider 270 and consumer 280 to filter data and/or block data that may be associated with a network attack having malicious purposes. Management hub 150, however, may operate outside the subscriber's (e.g., provider 270 and/or consumer 280) firewall.

In an exemplary implementation, management layer 210 and broker 220 may be located in the same server/computing device and proxies 230 and 232 may be distributed in network 200. In other implementations, broker 220 may be implemented in a separate device/system than management layer 210. In still other implementations, proxies 230 and 232 may be co-located with management layer 210 and/or broker 220. In other words, components of management hub 150 may be centralized, distributed or a combination of centralized and distributed in network 200 based on the particular implementation.

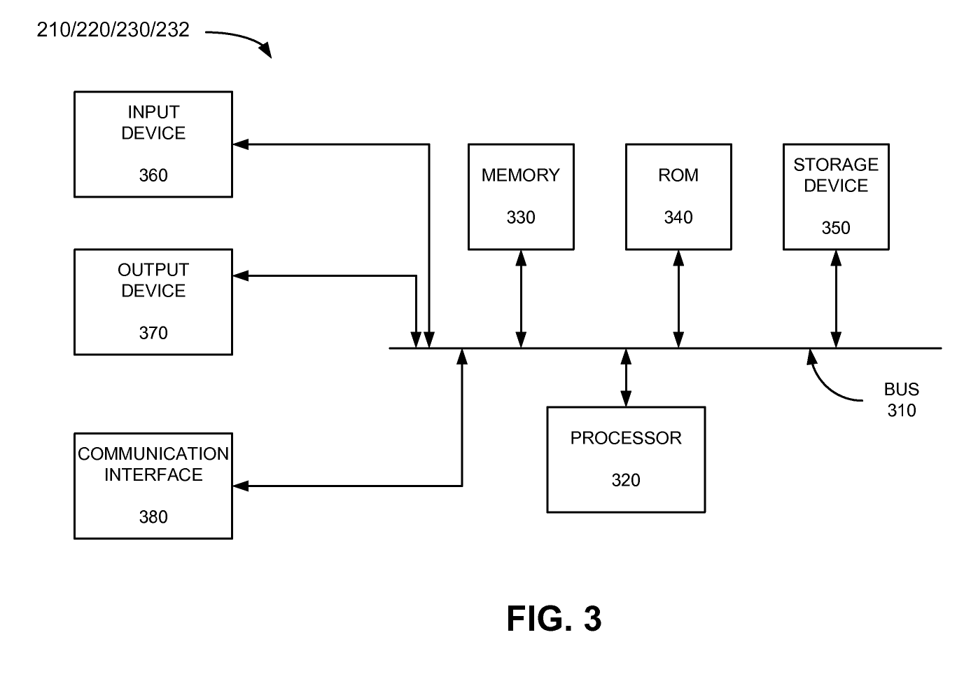

FIG. 3 illustrates an exemplary configuration of a device/system in which management layer 210 may be implemented. As discussed above, broker 220 may be implemented in the same device/system or a separate device. The description below assumes that management layer 210 and broker 220 are implemented in the same device/server/system. Proxies 230 and 232 may each be configured in a similar manner.

Referring to FIG. 3, management layer 210/broker 220 may include bus 310, processor 320, main memory 330, read only memory (ROM) 340, storage device 350, input device 360, output device 370, and communication interface 380. Bus 310 may include a path that permits communication among the elements of management layer 210/broker 220.

Processor 320 may include a processor, microprocessor, or processing logic that may interpret and execute instructions. Memory 330 may include a random access memory (RAM) or another type of dynamic storage device that may store information and instructions for execution by processor 320. ROM 340 may include a ROM device or another type of static storage device that may store static information and instructions for use by processor 320. Storage device 350 may include a magnetic and/or optical recording medium and its corresponding drive.

Input device 360 may include a mechanism that permits an operator to input information to management layer 210/broker 220 (or proxies 230 or 232), such as a keyboard, a mouse, a pen, voice recognition and/or biometric mechanisms, etc. Output device 370 may include a mechanism that outputs information to the operator, including a display, a printer, a speaker, etc. Communication interface 380 may include any transceiver-like mechanism that management layer 210/broker 220 use to communicate with other devices and/or systems. For example, communication interface 380 may include a modem or an Ethernet interface to a LAN. Alternatively, communication interface 380 may include other mechanisms for communicating via a network, such as network 290.

Management layer 210 and broker 220 may perform processing associated with managing the overall operation of management hub 150, as described in detail below. Proxies 230 and 232 may perform processing associated with providing for secure transactions and transport delivery between various entities in network 200. According to an exemplary implementation, management layer 210/broker 220 and proxies 230 and 232 may perform these operations in response to their respective processors 320 executing sequences of instructions contained in a computer-readable medium, such as their respective memories 330. A computer-readable medium may be defined as a physical or logical memory device and/or carrier wave.

The software instructions may be read into memory 330 from another computer-readable medium, such as data storage device 350, or from another device via communication interface 380. The software instructions contained in memory 330 may cause processor 320 to perform processes that will be described later. Alternatively, hard-wired circuitry may be used in place of or in combination with software instructions to implement processes consistent with the principles of the invention. Thus, implementations described herein are not limited to any specific combination of hardware circuitry and software.

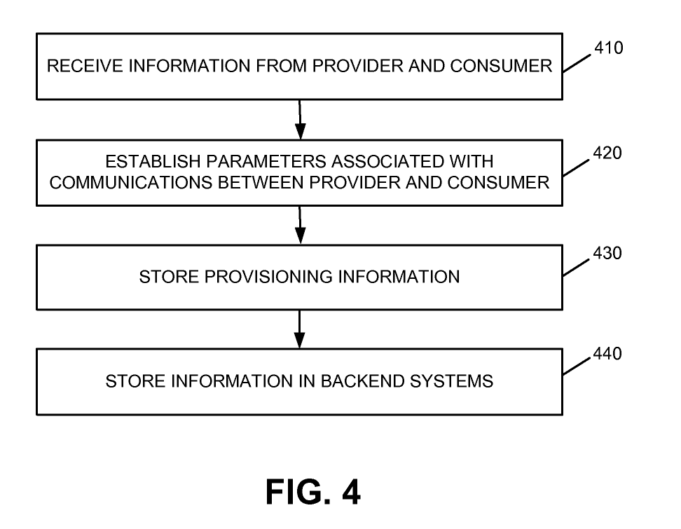

FIG. 4 is a flow diagram illustrating exemplary processing associated with managed peer-to-peer services in network 200. Processing may begin when various entities, such as provider 270 and consumer 280, establish a relationship with management hub 150 to subscribe to services provided by management hub 150. For example, provider 270 and consumer 280 may be two entities that wish to exchange information, services, etc. in network 200. Each of provider 270 and consumer 280 may then forward information to management hub 150 via a secure proxy or portal (e.g., proxy 230 or 232). Management hub 150 may receive the information from provider 270 and consumer 280 via the proxies (act 410).

The received information may include SLA information associated with communications between provider 270 and consumer 280 or other information identifying parameters associated with an expected service, such as an expected QoS associated with communications between these entities. The received information may also include information identifying particular protocols/standards executed by provider 270 and consumer 280. The particular protocols/standards executed by provider 270 and consumer 280 may be different in various instances. The received information may also include information identifying a level of security for communications between these entities (e.g., what type of encryption to use, what type of message validation to use, etc.).

The received information may be received at or forwarded to provisioning system 250. Provisioning system 250 may then identify what particular services that management hub 150 will perform to facilitate communications between provider 270 and consumer 280 and establish parameters for implementing the services (act 420). For example, provisioning system 250 may determine that proxies 230 and 232 may need to modify a particular data message received by provider 270, such as perform an XSL transformation, so that it will be compatible or usable by consumer 280. Provisioning system 250 may also identify security related requirements to be performed by management hub 150. That is, as discussed above, management hub 150 may perform security related processing, such as encryption, decryption, providing digital signatures, etc. The particular level or depth of these services, such as the particular level of encryption, may be based on the agreed upon SLA between provider 270 and consumer 280.

In each case, provisioning system 250 may store provisioning related information in provisioning data storage 260 (act 430). The provisioning related information may be used by proxies 230 and 232 to facilitate communications between provider 270 and consumer 280, as described in detail below.

Management layer 210 may also store information regarding communications between provider 270 and consumer 280 and/or forward information regarding communications between provider 270 and consumer 280 to backend systems 240 for storage (act 440). For example, management layer 210 may receive transaction information from proxies 230 and 232 via broker 220. This transaction information may include, for example, a transaction identifier (ID), information identifying the origination and destination parties associated with the message, the size of the message, time stamp information, an identifier of a network element involved in the transaction (e.g., one of proxies 230 or 232), etc. Management layer 210 may store all or a portion of this transaction information in various ones of backend systems 240 for processing by the respective backend systems, as described in more detail below. Alternatively, management layer 210 may store this transaction information locally, such as on storage device 350 (FIG. 2), for access by backend systems 240.

As one example, a billing system included in backend systems 240 may use the stored transaction information for billing entities (e.g., one or both of provider 270 and consumer 280) in network 200 in an accurate manner based on the particular agreed upon parameters, as described in detail below. That is, the billing system may allow for detailed billing of each transaction, each communication session, etc., based on the agreed upon parameters. As another example, a monitoring system included in backend systems 240 may use the stored transaction information to determine whether communications between entities in network 200 meet QoS requirements, SLAs, etc.

After provider 270 and consumer 280 have established agreed upon parameters with respect to exchanging information in network 200 and management hub 150 has processed the agreed upon parameters, provider 270 and consumer 280 may communicate in a transparent manner with respect to management hub 150. That is, provider 270 and consumer 280 may exchange information, services, etc., with little to no additional processing with respect to management hub 150, as described in detail below.

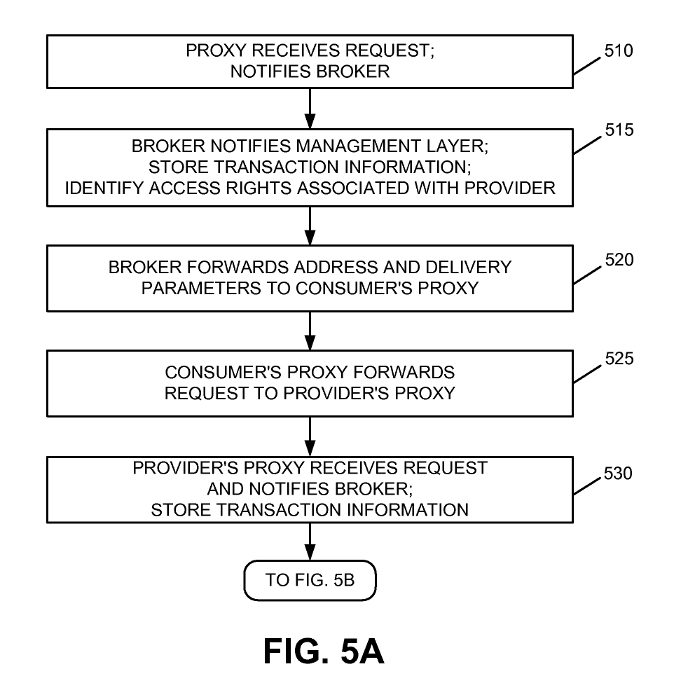

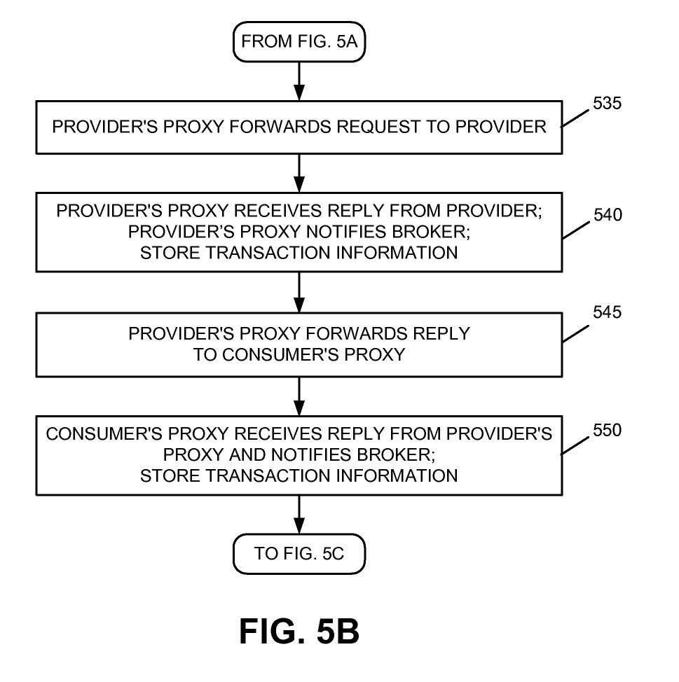

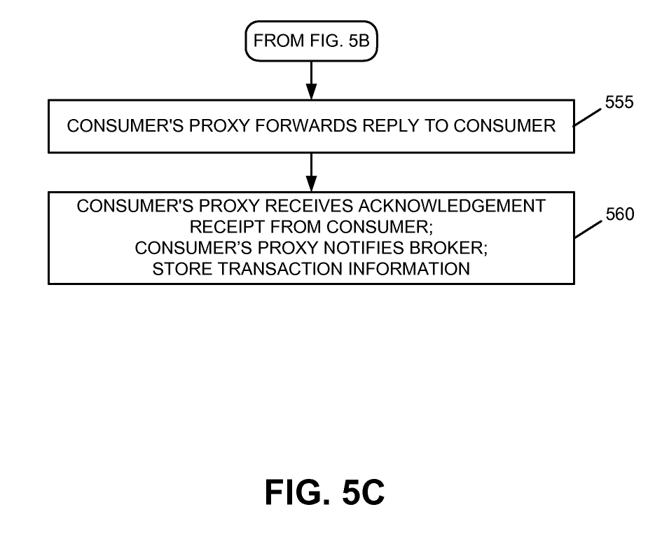

FIGS. 5A-5C are diagrams illustrating exemplary processing associated with processing requests in network 200. In this case, assume that provider 270 and consumer 280 have already established agreed upon parameters as described above with respect to FIG. 4 and that management hub 150 has performed the necessary processing to facilitate transactions between provider 270 and consumer 280. Processing may begin when consumer 280 generates and forwards a request for services to a provider, such as provider 270. The request may be, for example, a request for web related services, such as a request for information from provider 270, and may be transmitted in accordance with secure hypertext transfer protocol (HTTPS). Consumer 280 may forward the request to management hub 150 via network 290. For example, consumer 280, as described above, may be a subscriber to services provided by management hub 150. In this case, consumer 280 may be configured to forward such requests to a URL associated with management hub 150.

The URL may correspond to a proxy in network 200 that is located closest (e.g., physically and/or logically) to consumer 280. For example, assume that the URL is associated with proxy 232 and that proxy 232 will act as consumer's 280 proxy for facilitating communications to/from consumer 280 in network 200. Proxy 232 receives the request (act 510). As discussed above, the request may be associated with a request for information, a request for services or any other request. For example, provider 270 may be associated with a web site with which consumer 280 has contracted via an SLA to provide various information to consumer 280 in a manner similar to that described above with respect to FIG. 4. In this case, the request may include information identifying the party to whom the request is directed, which in this example is provider 270. Proxy 232 may notify broker 220 of the request and provide transaction information associated with the request to broker 220 (act 510). As discussed previously, the transaction information may include, for example, a transaction ID, information identifying the origination and destination parties associated with the message, the size of the message, time stamp information, an identifier of a network element involved in the transaction (e.g., proxy 232 in this example), etc. In one implementation, proxy 232 may request that broker 220 identify the appropriate proxy in network 200 associated with provider 270. This request may be forwarded via a control message sent to broker 220 along with the transaction information. The control message to broker 220 may also request that broker 220 identify access rights and/or requirements associated with accessing provider 270.

Broker 220 may receive the request and notify management layer 210 of the request (act 515). Broker 220 may also forward the transaction information to management layer 210. Upon receipt of this request and the transaction information, management layer 210 may store all or some of the transaction information in, for example, storage device 350 (act 515). Management layer 210 may also identify access rights associated with accessing provider 270 and identify the proxy associated with provider 270 (act 515). The access rights associated with provider 270 may identify particular requirements associated with accessing provider 270, such as particular security requirements (e.g., encryption levels, message validation requirements, signature requirements, etc.) associated with accessing provider 270. The requirements may also include QoS requirements, SLA information, message transformation requirements, message compression requirements, etc.

Management layer 210 may then determine whether consumer 280 is allowed to access provider 270. For example, management layer 210 may access an internal memory (e.g., storage device 350) and/or an external memory, such as provisioning data storage 260, to determine whether consumer 280 should be granted permission to access provider 270. This determination may be made based on various properties associated with consumer 280, such as whether consumer 280 is pre-approved to communicate with provider 270, whether provider 270 and consumer 280 have previously agreed to interact via the process described above with respect to FIG. 4, etc.

Assume that management layer 210 determines that consumer 280 is permitted to access provider 270. Further assume that management layer identifies proxy 230 as the distributed proxy in network 200 associated with provider 270. Management layer 210 may then initiate a data exchange with broker 220 that indicates that permission for consumer 280 to access provider 270 is granted. Management layer 210 may also forward location information associated with proxy 230 (e.g., a URL address of proxy 230) and delivery service parameters to broker 220. These delivery service parameters may provide information identifying various parameters required for communications to/from provider 270. Broker 220 may then forward the location information of proxy (e.g., the URL address) and the delivery parameters to the proxy associated with consumer 280 (i.e., proxy 232 in this example) (act 520).

Proxy 232 receives the information from broker 220. Proxy 232 may then perform any necessary processing in accordance with the received delivery service parameters. For example, proxy 232 may perform message encryption, generate a digital signature for forwarding with the message, perform data compression on the message, transform the message into a format compatible with provider 270, etc. Proxy 232 may then send the processed message data to the identified proxy associated with provider 270 (i.e., proxy 230 in this example) (act 525). For example, proxy 232 may generate a message using the received URL address and include the processed message data in the communication to proxy 230. The processed message data included in the communication to proxy 230 may correspond to the information in the initial request from consumer 280 intended for provider 270. In an alternative implementation, the processed message data may be attached to, for example, an initial communication from proxy 232 to proxy 230. It should be noted that proxy 230 and proxy 232 may be connected via a network, such as a LAN, a WAN, the Internet or some other private or public network (e.g., the PSTN). It should also be noted that intermediate proxies may be included in network 200 between proxies 232 and 230. In this case, proxy 232 may forward the message data to one or more other proxies, which ultimately forward the data to proxy 230. Each intermediate proxy that receives the message data may forward transaction information, such as the transaction information described above (i.e., a transaction ID, information identifying the origination and destination parties associated with the message, the size of the message, time stamp information, an identifier of a network element involved in the transaction), to broker 220. Broker 220 may then forward this transaction information to management layer 210 for use by backend systems 240. In this manner, the transmission of message data between subscribers (e.g., consumer 280 and provider 270) may be traced back at a later time for various purposes.

In each case, proxy 230 receives the request message and notifies broker 220 that it received the request, along with transaction information (act 530). Broker 220 may forward the transaction information to management layer 210. Management layer 210 may then store the appropriate transaction information (act 530). The transaction information, as described above, may include a transaction ID, information identifying the origination and destination parties associated with the message, the size of the message, time stamp information, a proxy ID identifying the proxy that forwarded the transaction information (i.e., proxy 230 in this example) and other information that may be used by backend systems 240 for various purposes.

Proxy 230 may perform various processing on the received message, such as decrypt the message, perform message validation, de-compress the message, etc., to determine the authenticity of the message. Proxy 230 may also perform processing to ensure that the message is in a format compatible with provider 270 such that provider 270 will be able to determine the contents of the request. Proxy 230 may then forward the request message to provider 270 (act 535). In some implementations, proxy 230 may forward the message in accordance with HTTPS.

Provider 270 may receive the request and send, for example, a reply message to proxy 230. The reply message may include the requested message data. Proxy 230 may receive the reply message (act 540). The reply may also include the requested information for consumer 280. For example, the reply message may include message data that is responsive to consumer's 280 initial request for information. The requested information may be embedded in the reply message or attached to the reply message. Upon receipt of this reply, proxy 230 may notify broker 220 and send transaction information to broker 220 (act 540).

The transaction information, as discussed above, may include, for example, a transaction ID, information identifying the origination and destination parties associated with the message, the size of the message, time stamp information, a proxy ID identifying proxy 230, etc. Broker 220 may forward the transaction information to management layer 210, which may then store the transaction information in, for example, storage device 350 (act 540).

Proxy 230 may also perform address resolution associated with delivering the message to consumer 280 and send a reply message including the requested information to proxy 232 (act 545). That is, proxy 230 may identify a location (e.g., a URL) associated with consumer's 280 proxy (i.e., proxy 232 in this example). Proxy 230 may also perform various security related processing associated with the message. For example, proxy 230 may perform data encryption, provide a message signature, etc., in accordance with the agreed upon parameters associated with communications between provider 270 and consumer 280. Proxy 230 may also perform additional processing, such as data compression, data format conversion, data transformation, etc., to ensure that the data is in a format compatible with consumer 280. In some instances, proxy 230 may communicate with management layer 210 via broker 220 to determine the particular processing to perform on the received message, such as what type of security-related processing, compression, conversion, transformation, etc., to perform. This information may be provided by management layer 210 to proxy 230, via broker 220, using control messages.

Proxy 232 may receive the reply message (act 550). Upon receipt of this reply message, proxy 232 may notify broker 220 that it received the reply message from proxy 230 (act 550). Proxy 232 may also forward transaction information to broker 220. The transaction information may include a transaction ID, information identifying the origination and destination parties associated with the message, the size of the message, time stamp information, a proxy ID identifying proxy 232 and other information.

Broker 220 may receive the transaction information and may forward all or some of the transaction information to management layer 210, which may store the transaction information in, for example, storage device 350 (act 550). Proxy 232 may also forward the reply to consumer 280 (act 555). The reply message may include information responsive to the initial request message. Consumer 280 may then acknowledge the receipt of the reply message. Proxy 232 may receive the acknowledgement from consumer 280 and notify broker 220 that consumer 280 has received the reply message (act 560). Broker 220 may then forward transaction information to management layer 210, which may then store the transaction information in, for example, storage device 350 (act 560). Backend systems 240 may use the stored transaction information for various purposes. For example, a billing system included in backend systems 240 may use the stored transaction information for billing one or both of provider 270 and consumer 280 for the particular transaction/communication session, for auditing purposes, for monitoring purposes, such as monitoring QoS, SLA compliance, or for other purposes.

As described above, management hub 150 acts as a broker and/or manager to manage communication sessions in a peer-to-peer environment. In an exemplary implementation, management hub 150 separates control information and message data in network 200. For example, control information may be sent by proxies 230 and 232 to broker 220 and/or management layer 210 for identifying various information (e.g., SLA information, QoS information, security related information, compatibility related information, etc.) to facilitate communications between consumer 280 and provider 270 and to ensure that the communications are performed in accordance with agreed upon parameters.

In an exemplary implementation, message data, such as requests for information from an entity (e.g., provider 270) and message data provided in response to such requests, may be sent between proxies 230 and 232 without requiring that the message data be sent to broker 220 and/or management layer 210. This allows management hub 150 to process information from a large number of subscribers without slowing down processing. That is, broker 220 and/or management layer 210 may not receive and/or process the actual message data transmitted between subscribers (e.g., provider 270 and consumer 280). This enables management hub 150 to facilitate communications sessions for a large number of subscribers in an efficient manner. That is, by not receiving and/or storing message data, management hub 150 may quickly process transaction information and forward message data to subscribers.

In addition, as described above, proxies 230 and 232 may forward transaction information associated with communication sessions to broker 220. This transaction information enables management hub 150 to perform a number of services associated with the communication sessions. For example, management hub 150 may use the transaction information to ensure that communication sessions may be accurately billed based on the particular services performed. Management hub 150 may also use the transaction information to monitor the communication sessions for compliance with agreed upon parameters, as well as analyze the communication sessions for other purposes, based on the particular implementation and the particular subscriber requirements.

In addition, when changes are made to various equipment and/or procedures associated with one or both of provider 270 and consumer 280, provider 270 and/or consumer 280 may notify management hub 150 of the changes and management hub 150 may perform various processing needed to ensure that the changes are reflected at management hub 150. This enables management hub 150 to provide on-going support and change management to ensure that both entities (e.g., provider 270 and consumer 280) are able to communicate with each other in accordance with agreed upon parameters.

Implementations described herein also provide operational automation for service providers and customers when communicating over a network. For example, security related processing, compatibility related processing, accounting related processing, auditing related processing and monitoring related processing may be performed by management hub 150 that allows both providers and consumers to simplify their processing.

The foregoing description of exemplary implementations provides illustration and description, but is not intended to be exhaustive or to limit the invention to the precise form disclosed. Modifications and variations are possible in light of the above teachings or may be acquired from practice of the invention. For example, various features have been described above with respect to components in management hub 150. In some implementations, the functions performed by some of these components may be performed by other components. In other implementations, the functions described as being performed by multiple components may be performed by a single component.

In addition, while the transaction described above focused on a single provider and a single consumer, it should be understood that a large number of providers and consumers may interact via management hub 150. Further, a communication session involving a single request from one entity (i.e., consumer 280) to another entity (i.e., provider 270) and the reply message has been described above. It should be understood that a typical communication session or request for service, information, etc., may involve multiple communications between the entities. In each case, management hub 150 may perform processing to facilitate the multiple communications and also store transaction information associated with each communication.

In addition, while series of acts have been described with respect to FIGS. 4 and 5A-5C, the order of the acts may be varied in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting of the invention. Thus, the operation and behavior of the aspects of the invention were described without reference to the specific software code—it being understood that one would be able to design software and control hardware to implement the various features based on the description herein.

Further, certain portions of the invention may be implemented as “logic” that performs one or more functions. This logic may include hardware, such as a processor, a microprocessor, an application specific integrated circuit, or a field programmable gate array, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A system, comprising:
a management platform; and
a first proxy configured to:
receive a request from a first subscriber of network services provided by the system, the request being intended for a second subscriber of network services provided the system, and
forward control information associated with the request to the management platform;
wherein the management platform is configured to:
receive the control information associated with the request from the first proxy,
identify requirements associated with communications between the first and second subscribers, and
forward the requirements to the first proxy;
wherein the first proxy is further configured to:
receive the requirements from the management platform,
process the request in accordance with the identified requirements, and
forward message data associated with the processed request to a second proxy associated with the second subscriber.

2. The system of claim 1, wherein the first proxy is further configured to:
process the request to provide security related features in accordance with the identified requirements associated with communications between the first and second subscribers.

3. The system of claim 2, wherein when processing the request to provide security related features, the first proxy is configured to:
perform at least one of encryption or message validation.

4. The system of claim 1, further comprising:
the second proxy, wherein the second proxy is configured to:
receive the message data from the first proxy,
perform security related processing or compatibility related processing on the message data, and
forward the processed message data to the second subscriber.

5. The system of claim 1, wherein the first proxy is further configured to:
forward, for each request received from the first subscriber, control information to the management platform, and
forward, for each request received from the first subscriber, message data to a proxy associated with an intended recipient of the request, wherein the message data is not forwarded to the management platform.

6. The system of claim 1, wherein the management platform is further configured to:
identify the second proxy associated with the second subscriber,
identify access entitlements associated with the second subscriber, and
forward, to the first proxy, control information identifying the second proxy and the access entitlements.

7. The system of claim 1, wherein when identifying requirements, the management platform is configured to:
identify transformation information associated with communications from the first subscriber to the second subscriber, and
forward the transformation information to the first proxy,
wherein the first proxy is configured to:
modify the request in accordance with the transformation information, and
forward the modified request to the second proxy.

8. The system of claim 1, further comprising:
at least one backend component configured to:
receive transaction information associated with a communication session between the first and second subscribers, the transaction information comprising at least one of a transaction identifier, information identifying origination and destination parties associated with a message transmitted between the first and second subscribers, a size of the message, time stamp information or a proxy identifier identifying a proxy associated with the message, and
perform at least one of billing related processing, auditing related processing, monitoring related processing or statistical analysis related processing based on the transaction information.

9. The system of claim 8, wherein the at least one backend component comprises a billing component, wherein the billing component is configured to:
identify billing parameters agreed to by the first and second subscribers, and
generate billing information based on the billing parameters and the received transaction information.

10. In a platform comprising a plurality of distributed proxies and a hub, a method comprising:
receiving, at a first proxy, a communication from a first entity intended for a second entity;
forwarding control information associated with the communication from the first proxy to the hub;
identifying, by the hub, parameters associated with communications between the first and second entities;
forwarding the parameters to the first proxy;
processing, by the first proxy, the communication in accordance with the parameters;
forwarding, by the first proxy, the processed communication to a second proxy; and
forwarding, by the second proxy, the processed communication to the second entity.

11. The method of claim 10, wherein the identifying parameters comprises:
identifying access requirements associated with the second entity, and
forwarding information identifying the access requirements to the first proxy.

12. The method of claim 10, wherein the processing by the first proxy comprises:
performing at least one of security related processing or compatibility related processing in accordance with the identified parameters associated with communications between the first and second entities.

13. The method of claim 12, wherein the performing at least one of security related processing or compatibility related processing comprises:
performing at least one of encryption, message validation or generating a message signature.

14. The method of claim 10, wherein the identifying parameters comprises:
identifying transformation information associated with communications from the first entity to the second entity; and
forwarding the transformation information to the first proxy.

15. The method of claim 14, wherein the processing by the first proxy comprises:
modifying the communication from the first entity in accordance with the transformation information.

16. The method of claim 10, further comprising:
forwarding, by the first and second proxies, transaction information associated with a communication session between the first and second entities to the hub; and
using the received transaction information for at least one of billing, auditing, monitoring or statistical analysis.

17. The method of claim 16, wherein the using the received transaction information comprises:
identifying an amount of data associated with communication session,
identifying billing parameters agreed to by the first and second entities, and
generate billing information based on the amount of data and the billing parameters.

18. The method of claim 10, further comprising:
receiving, by the second proxy, a reply from the second entity;
processing, by the second proxy, the reply in accordance with second parameters associated with communications from the second entity to the first entity; and
forwarding, by the second proxy, the processed reply to the first proxy.

19. The method of claim 10, further comprising:
forwarding, by the first and second proxies, control information and transaction information to the hub for communications involving the first and second entities; and
forwarding, by the first and second proxies, message data associated with communication sessions involving the first and second entities to at least one other proxy associated with the intended recipient of the message data, wherein the message data is not forwarded to the hub.

20. A system, comprising:
proxy means for receiving a communication from a first entity intended for a second entity and for forwarding control information associated with the communication to a hub means;
hub means for receiving the control information and identifying requirements associated with communications between the first and second entities;
means for processing, by the proxy means, the communication in accordance with the identified requirements; and
means for forwarding, by the proxy means, message data associated with the processed communication to the second entity.

21. The system of claim 20, wherein the proxy means forwards control and transaction information to the hub means and does not forward message data associated with a communication session between the first and second entities to the hub means.
